(19) United States
(12) Patent Application Publication
(10) Pub. No.: US 2009/0238168 A1
(43) Pub. Date: Sep. 24, 2009

(54) COMMUNICATION NODE AND METHOD FOR HANDLING SIP COMMUNICATION

(75) Inventors: Dominic Lavoie, Saint-Laurent (CA); Stephan Goulet, Lachine (CA); Sebastien Trottier, Pointe-Claire (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: PARAXIP TECHNOLOGIES INC., Montreal (CA)

(21) Appl. No.: 12/050,323

(22) Filed: Mar. 18, 2008

(51) Int. Cl. H04L 12/66

(52) U.S. Cl. 370/352

(57) ABSTRACT

The present invention relates to a communication node and method for connecting and maintaining a call between a caller device and a callee device. The communication node comprises a session controller module and a plurality of internal SIP UA (Session Initiation Protocol User Agent) servers. The session controller module is adapted to remain in communication with the caller device and the callee device through a whole duration of the call. The plurality of internal SIP UA servers is adapted to communicate with the session controller module by open protocol.

### FIELD OF THE INVENTION

The invention relates to a communication node and method for handling SIP (Session Initiation Protocol) communication.

### BACKGROUND OF THE INVENTION

Over the past decade, long utilized wireline communication systems have been gradually replaced by Internet technology. The Internet technology is a common platform for transferring data from one device to another over a network of routers. For instance, VOIP (Voice Over Internet Protocol) technology is an area of application for transmitting voice data on an Internet network.

VOIP is favored over the conventional wireline technology as it is considered to be cheaper, more scalable and flexible. With VOIP, the devices are compatible with numerous Internet application services that can easily be added and maintained. As a consequence, the demand for use of the Internet technology in the area of telephony is on the increase. This foreseen growth has required multiple organizations to collaborate in establishing norms for managing and handling communication over Internet networks. One of the numerous norms that has seen light is SIP (Session Initiation Protocol), SIP was principally developed to manage call signaling over Internet networks. More precisely, SIP is conventionally used in the establishment and termination of call sessions.

According to the latest SIP specification RFC3261, SIP is an application-layer control protocol for creating, modifying and terminating sessions with at least one participant, also known as SIP UA (User Agent). It can be used to create two-party, multiparty or multicast sessions that comprise Internet telephone calls, multimedia distribution and multimedia conferences.

The underlying philosophy of SIP is to remove complexity from the core of the network and push the complexity to the edge, towards the SIP UA endpoints, such as a caller device and a callee device. By pushing the complexity to the edge of the network, greater flexibility and scalability is achieved. In simple applications, the caller device interacts directly with the callee device and SIP is used briefly during call session setup and teardown.

In more complex applications of SIP, the network between the caller device and the callee device may comprise UAs that perform, among others, the functions of locating callee device and routing calls. For example, a SIP proxy sewer is located between the caller device and the callee device for establishing call connections and routing calls.

The simplest implementation of a SIP proxy server is the redirect server. The redirect server obtains a list of potential callee locations from a registrar. This list is forwarded to the caller in a SIP 3XX redirect message. The caller then performs the search for the callee itself. This is a typical example of the SIP philosophy of removing complexity from core elements to push it at the edge in the endpoints.

While the SIP approach has the advantage of being flexible, scalable and maintainable, the implementation of endpoints such as caller device and callee device is more complex because of the rich feature set they must support. This issue slows down the adoption of the protocol and makes the deployment of applications very complex. The deployment of applications is more complex, as several heterogeneous SIP UAs are normally present in a network. This causes compatibility issues because the scope and quality of the implementation of the SIP protocol can vary greatly from UA to UA.

A B2BUA (Back to Back User Agent) was introduced to limit the necessity of implementing all SIP features in the endpoints. Unlike the SIP proxy server, which may only maintain a transaction state, the B2BUA must maintain the complete call state and participate in all call requests. The B2BUA acts as a SIP UA server to the caller device and as a SIP UA client to the callee device during a SIP call. In other words, the B2BUA is responsible of handling all SIP signaling between both ends of the SIP call, from call establishment to termination. In addition to handling SIP messages, B2BUAs typically also handle media streams such as RTP streams. The B2BUA provides services such as call management, network interworking, hiding of network internals and codec translations between two call legs.

Although existing B2BUAs are capable of fixing compatibility issues between SIP UAs and is capable of providing services during the whole duration of a call, the use of B2BUAs removes the flexibility and scalability advantages for which SIP networks where designed in the first place. For example, the B2BUA is involved during signaling control and media control, however signaling control and media control have different requirements in terms of scalability. As the B2BUA isn't capable to adapt to both signaling control and media control requirements, the B2BUA results into a less flexible solution.

Additionally, network congestion is likelier to occur through the usage of B2BUA as the B2BUA acts as a bottleneck in the network when particular services are in high demand. When particular services are in high demand, the B2BUA must refuse service requests, thus lowering the quality of service for the network.

There is therefore a need to provide a communication node and method for handling SIP communication that is flexible and scalable to the network demand.

### SUMMARY OF THE INVENTION

The present invention relates to a communication node and method for handling SIP (Session Initiation Protocol) communication between a caller device and a callee device. More specifically the communication node and method is for connecting and maintaining a SIP communication between the caller device and the callee device. The communication node is located between the caller device and the callee device in a SIP communication network.

The communication node comprises a plurality of modules that, among others, are adapted to solve connectivity issues, compatibility issues and also provide value-added services. The modules comprised in the communication node may vary from one embodiment to another. According to an aspect of this invention, the communication node comprises a session controller module for managing and dispatching tasks to other modules such as internal SIP UA (User Agent) servers.

More specifically, the session controller module is adapted to manage and dispatch tasks according to the detected compatibility issues and connectivity issues between the caller device and callee device. Additionally, the session controller module is adapted to manage and dispatch tasks according to at least one requested value added service. In a particular embodiment of the present invention, the session controller is also an internal Back to Back User Agent (B2BUA).

The session controller module is adapted to manage and dispatch various tasks to at least one internal SIP UA through an open protocol communication means. Additionally, according to another aspect of this invention, the modules such as internal SIP UA servers are adapted to interact with each other through an open protocol communication.

According to yet another embodiment, the communication node is adapted to respond to on-the-fly requests for solving issues or for providing value-added services during the call. To provide such flexibility, the session controller module remains in communication with the caller device and the callee device throughout the whole duration of the call.

### BRIEF DESCRIPTION OF THE DRAWINGS

For a better understanding of embodiments of the communication nodes and method described herein, and to show more clearly how they may be carried into effect, reference will be made by way of example, to the accompanying drawings in which:

FIG. 1 is a block diagram depicting a communication node in accordance with an embodiment of the invention along with components that interact with the communication node;

FIG. 2 is a block diagram depicting another embodiment of a communication node of the present invention along with components that interact with the communication node;

FIG. 3 is a block diagram depicting another embodiment of a communication node of the present invention;

FIG. 4 is a sequence diagram depicting interactions between modules contained within the communication node of the present invention, and the interactions between the components that interact with the communication node;

FIG. 5 is a block diagram depicting interactions between communication ports according to another embodiment of a communication node of the present invention; and

FIG. 6 is a format of a SIP (Session Initiation Protocol) message for which a communication node is adapted to process according to an embodiment of this invention.

### DETAILED DESCRIPTION OF THE INVENTION

The present application relates to a communication node and method for handling SIP (Session Initiation Protocol) communication. In general, SIP communication is used in VOIP (Voice Over Internet Protocol) technology. VOIP is an area of application for transmitting voice data on a network based on the Internet Protocol (IP). More specifically, the communication nodes and method of the present invention are adapted for connecting and maintaining the SIP communication during a call between a caller device and a callee device in a flexible and efficient way.

According to the latest SIP specification RFC3261, SIP is an application-layer control protocol for creating, modifying and terminating sessions with at least one SIP UA (User Agent). The SIP UA is a client application or a server application that is adapted to communicate using SIP. For example, within a call the caller device is a SIP UA client while the callee device is a SIP UA server. The network between the caller device and the callee device may also comprise other SIP UAs.

SIP can be used to create two-party, multiparty or multicast sessions that comprise Internet telephone calls, multimedia distribution and multimedia conferences. Although reference is made to RFC3261 throughout the present specification, the latter is not limited to any version of SIP, but is rather directed to all similar protocols that allow signaling over the Internet Protocol for voice and/or multimedia communications.

The philosophy of SIP is to have highly scalable core network elements. To conform to the philosophy of SIP, the communication node disclosed in the present invention gives the possibility to address a maximal number of compatibility issues in order to assure the establishment of a session. In addition to addressing compatibility issues, the communication node is capable of solving connectivity issues while providing complementary services that are related to connectivity issues such as call recording. The communication node has also the capacity to remove from the endpoints the burden of implementing the full RFC3261 SIP standard. The aim here is to maximize the number of heterogeneous endpoints that can seamlessly interact in a given environment such as in a call center, an enterprise, or in any other kind of environment.

Although the following description solely refers to SIP communication, the present invention is not limited in its applicability to SIP, but rather applies to any form of open protocol communication, of which SIP is an example thereof.

### Communication Node

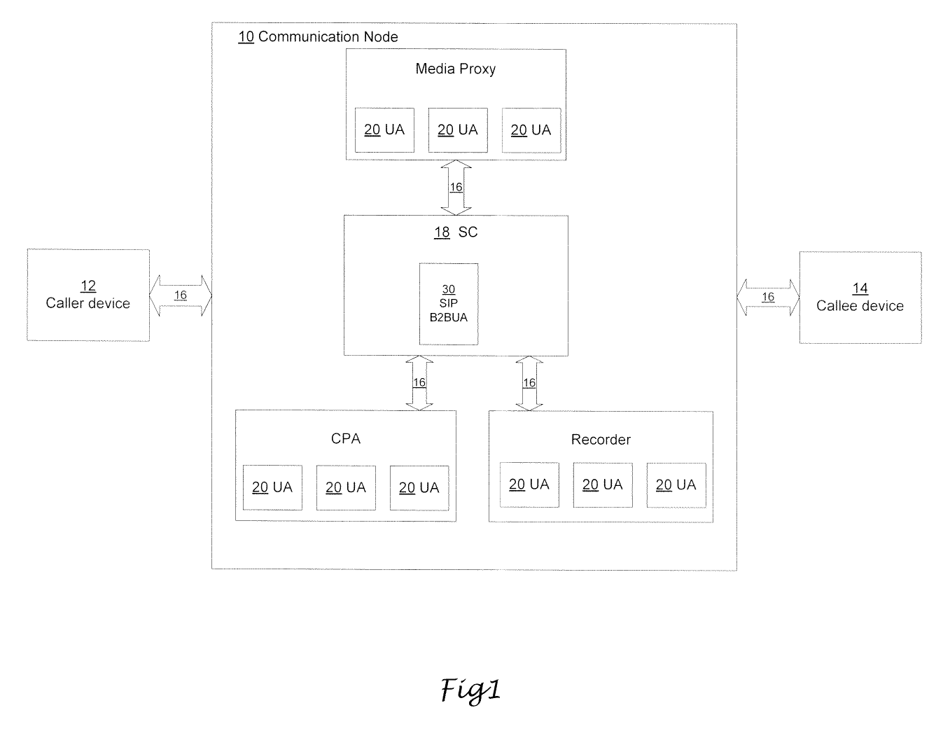

Presented in FIG. 1 is a graphical representation of a communication node's 10 architecture. The communication node 10 comprises multiple modules for providing at least one service related to establishing or maintaining a SIP communication 16 between a caller device 12 or a callee device 14. For instance, during a SIP communication 16 between a caller device 12 and a callee device 14, the communication node 10 interposes itself between the caller device 12 and the callee device 14 so as to seamlessly provide a value-added service or to solve compatibility issues there between. For doing so, the communication node 10 of the present invention interposes itself on a signaling path of the communication between the caller device 12 and the callee device 14, throughout a whole duration of the communication therebetween. Furthermore, on a need-to-be basis, the communication node 10 interposes itself in a media path of the communication between the caller device 12 and the callee device 14. The interposition of the communication node 10 in the communication between the caller device 12 and the callee device 14 is performed in such a manner that the caller device 12 is not aware that it is actually in communication with the callee device 14 through the communication node 10 rather than directly with the callee device 14, and the callee device 14 is not aware that it is actually in communication with the caller device 12 through the communication node 10 rather than with the caller device 12 directly, which is referred hereinafter as seamless connection. The only aspect in which the caller device 12 is aware of the communication node 10 is that the initial request is sent to a session controller module 18 instead of the callee device 14. This is usually accomplished through a caller device 12 configuration mechanism such as a local outbound proxy. The content of the initial request message is exactly the same as if the communication node 10 did not intervene.

Additionally, the caller device 12 and the callee device are unaware of the internal structure of the communication node 10, i.e. its multiple modules. The modules of the communication node 10 enable the communication node 10 to successfully handle the SIP communications 16. The communication node 10 comprises various types of SIP UA based modules such as: a session controller module 18 and internal SIP UA servers 20. Although internal to the communication node 10, the modules communicate with each other by open protocol, such as SIP. This implementation of the communication node 10, with multiple internal modules communicating internally using SIP, provides a highly scalable and adaptable node.

In the foregoing specification, when reference is made to a module of the communication node, the singular and plural form should both be considered as possible alternate embodiments. It should further be noted that for sake of clarity, the graphical representation of the communication node of FIG. 1 omits modules such as input/output units, powering unit, and other such functions which are well known in the art, and which, although necessary for proper functioning of the communication node in the field, do not directly pertain to the understanding of the present invention or its realization.

Although the present description is limited to one caller device 12 and one callee device 14, such limitation is for clarity only. The communication node 10 of the present invention is capable and adapted for handling multiple caller devices 12 and multiple callee devices 14 simultaneously and concurrently.

### Session Controller

The session controller module 18 is essentially the brain of the communication node 10. More particularly, it is the point of control of the communication node 10 for both signaling path and media path of the communication between the caller device 12 and the callee device 14. For any incoming service request, the session controller module 18 manages its handling. The service request is analyzed and correlated to a given service or combination of services.

The session controller is in the signaling path between the caller device 12 and callee device 14 while the internal SIP UA servers 20 may intervene in the media path. At the same time, a signaling protocol such as SIP is used by the session controller to exchange information and control the internal SIP UA servers 20 The session controller is never in the media path and the internal SIP UA servers 20 never participate in the signaling that takes place between the caller device 12 and callee device 14. This separation of both the signaling and media path across distinct modules makes the node highly scalable.

The service request may originate from various types of entities. Possible entities that may request a service according to the present invention include: the caller device 12, the callee device 14, modules of the communication node 10, a network operator, a third party application and any entity or combination of entities that are may request a service for a call session.

Upon receipt of the incoming service request, the session controller module 18 executes specialized scripts. The specialized scripts enable the session controller module 18 to determine if an internal SIP UA server 20 must be involved or if it is capable to handle the service requested on it's own. Where internal SIP UA servers 20 are required the session controller module 18 dispatches thereto corresponding tasks required for performing the service corresponding to the incoming service request. On the other hand, where the session controller module 18 is capable of handling the service requested, the session controller module 18 acts as an internal SIP B2BUA and performs the service corresponding to the incoming service request. In certain cases a combination of tasks are sent to both the session controller module 18 and internal SIP UA server 20.

### Internal SIP B2BUA

In an aspect of the present invention, the session controller module 18 also acts as an internal SIP B2BUA 30 to resolve compatibility issues. Various types of compatibility issues may arise during a communication between a caller device 12 and a callee device 14. Examples of compatibility issues include: transport protocol related issues, non-compliance to SIP RFC 3261 communication, SIP message header formatting, etc.

More particularly, compatibility issues with respect to transport protocol is addressed by session controller module 18 when conversion of transport protocol is required to allow SIP communication 16 between the caller device 12 and the callee device 14. As SIP messages can be carried through multiple types of protocols, the session controller module 18 is required to convert the multiple types of protocols so as to allow establishment of communication transparently between a caller device 12 and a callee device 14. The session controller module 18 is thus capable of addressing single protocol conversion or conversions of multiple types of protocols such as UDP (User Datagram Protocol), TCP (Transmission Control Protocol), TLS (Transport Layer Security) etc.

In addition to performing transport protocol conversions, the session controller module 18 may further be adapted to process non-compliant SIP RFC 3261 communication. It is commonly known that SIP nodes are deployed with configurations of header formats that are variable from one vendor/provider to another. This lack of uniformity in the header of SIP messages sometimes prevents a caller device 12 from establishing SIP communication 16 with a callee device 14. To remedy the lack of uniformity in headers, session controller module 18 is adapted to process SIP messages with missing mandatory headers or with non-compliant formats of headers in order to allow establishment of the communication and completion of requested services between the caller device 12 and the callee device 14.

When a new compatibility issue is identified, the communication node 10 is adapted to be loaded with additional compatibility resolving scripts. Those compatibility scripts may further be loaded and executed in the session controller module 18, so as to allow dynamic upgrading and continuous improvement of incompatibility resolution capabilities.

### Internal SIP UA Server

Further presented in FIG. 1, multiple internal SIP UA servers 20 are located in the communication node 10. The internal SIP UA servers 20 are the “workers” of the communication node 10. They are loaded with scripts for executing a set of tasks that are either functionally related or that are related to a given service type.

It is the session controller module 18 that identifies the particular internal SIP UA server(s) 20 for executing the task or it is the internal SIP UA server 20 themselves that negotiate amongst each other to determine which internal SIP UA server 20 shall take charge of executing the task.

The internal SIP UA servers 20 have the capacity to execute diverse tasks that are related to numerous types of features such as to a media proxy service feature, a Call Progress Analysis (CPA) service feature, a recorder service feature, or any other type of feature required for providing a service on a signaling path or media path during a communication between the caller device 12 and the callee device 14.

Each internal SIP UA server 20 is capable of executing a specific task or group of tasks for one or a plurality of service features. Thus internal SIP UA servers 20 can either be dedicated to a particular service feature, to a particular class of service features or shared by multiple service features. Enabling sharing of SIP UA servers 20 by multiple service features provides greater flexibility to the communication node 10 in handling service requests. Such flexibility provides the possibility to adapt to the demand of particular services as it allows the re-assignment of a limitless number of internal SIP UA servers 20 for the particular services that are in higher demand.

Another aspect of the SIP UA servers 20 is their intrinsic flexibility. As the SIP UA servers 20 run loaded service scripts, it is thus possible to easily add new services to the communication node 10 by loading related service scripts in one or many of the SIP UA servers 20 for supporting the corresponding new services. Similarly, it is possible to provide SIP UA servers 20 capable of supporting all services supported by the communication node 10, and thus allowing for a totally flexible and scalable communication node 10.

### Media Stream Services

The communication node 10 is capable of providing various types of service features for handling media stream services such as a recorder service feature and a media proxy service feature. The following sections describe possible embodiments of this invention using the recorder service feature and/or the media proxy service feature, however it should be noticed that other types of service features may also be used for handling media stream services.

### Media Recording

The recorder service feature provides the possibility of recording media streams to a file. More particularly, the recorder service feature is useful in fields concerning security, training and quality monitoring. For recording an entire call, the session controller module 18 must, therefore, stay in the signaling path for the whole duration of the communication. As a result, the session controller module 18 requires the participation of the internal SIP UA server 20 that are adapted to execute functionalities of the recorder service feature and also of the media proxy service feature. The media proxy service feature is required for both implementations of recording, native recording and Media forking

In the case where a call is transferred during its recording, the session controller module 18 is capable of handling the transfer without relaying the transfer request to the participating caller device 12 or participating callee device 14. However, once the transfer is completed, the session controller module 18 reconfigures the internal SIP UA server 20 to make sure the internal SIP UA server 20 of the recorder service feature (if needed) is always connected to the proper media path, and particularly media stream.

Media recording can be performed natively by the media proxy. In this configuration, the session controller module 18 inserts the media proxy internal SIP UA server 20 in the signaling path between the caller device 12 and callee device 14. For sake of clarity, the media proxy internal SIP UA server 20 is referred below as a media proxy.

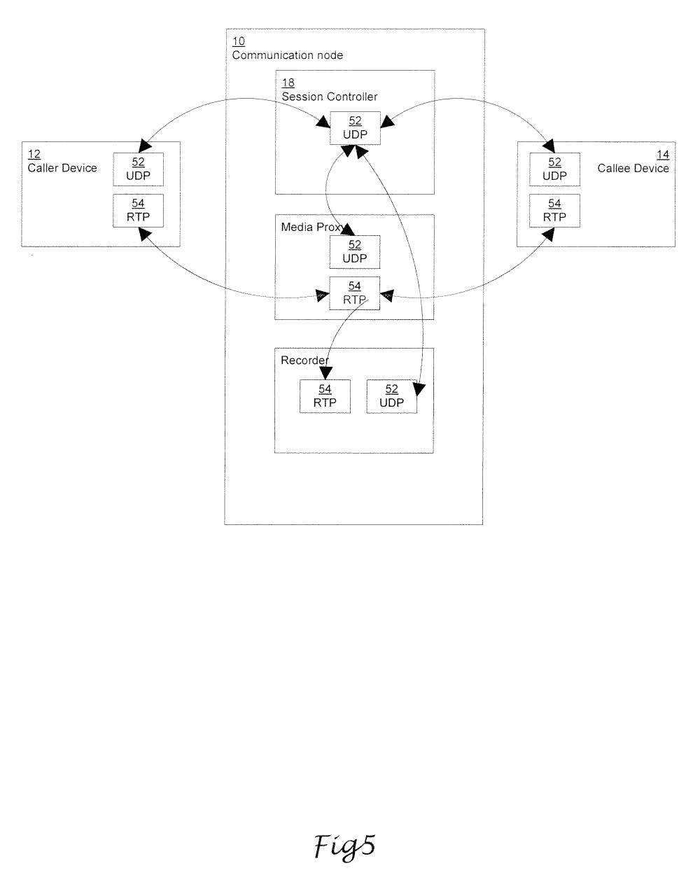

Such as presented in FIG. 5, to insert the media proxy in the media path, the session controller module 18 contacts the media proxy with a signaling protocol such as SIP to configure it for recording and to obtain the media addresses/ports on which it is expecting to receive media packets. This address/port information is relayed by the session controller module 18 to the caller device 12 and callee device 14 to inform them of where they should send their media. The same signaling protocol is also used by the session controller module 18 to inform the media proxy of where to send the media packets it receives, i.e. the caller device 12 and callee device 14 reception addresses/ports. Once the media proxy is inserted in the media paths between the caller device 12 and callee device 14 it sends copies of the processed media streams to a local storage device such as a disk.

Alternatively, as further presented in FIG. 5, media forking is used for implementing media recoding. Instead of storing the recorded media locally in the media proxy, the media streams are copied and forked to a recorder internal SIP UA server 20. This implementation allows the data to be stored on devices remote from the media proxy. In addition to using the procedure described above to insert the media proxy in the media path, the session controller module 18 uses SIP to establish a session with the recorder internal SIP UA server 20 to obtain the addresses/ports on which the recorder expects the media. The session controller relays this information to the media proxy that then takes care of duplicating the data and sending the data over to the previously established recorder address and port.

In an alternate embodiment of media recording, a third party recorder UA external to the communication node 10 is used in place of the recorder internal SIP UA server 20.

In the context of the present invention, the recorder service feature encompasses other media recording services that are handled by internal SIP UA servers 20.

n addition to executing media recording service requests, the media proxy service feature is capable of executing other service requests that concern the media stream such as media transcoding, protocol mediation, media forking, etc.

### Media Transcoding

Media transcoding is required when the caller device 12 and the callee device 14 do not support the same media codec (encoding and decoding algorithm). In such a case, internal SIP UA servers 20 are involved to perform media transcoding. For example, the caller device 12 that only supports the codec G.711 cannot communicate with the callee device 14 that only supports the codec G.729 without the intervention of the media proxy service feature. Protocol Mediation

Another example of the use of the media proxy service feature is for protocol mediation required during RFC2833 DTMF (Dual-Tone Multi-Frequency) mediation. DTMF are tones that are generated when a telephone key is pressed. The tones are either carried in-band as audible signals or out-of-band as special packets that indicate the start and end of the tones. The session controller module 18 is capable of detecting DTMF incompatibilities through a SDP (Session Description Protocol) of each caller device 12 and callee device 14. When a DTMF incompatibility is discovered, the session controller module 18 instructs the appropriate internal SIP UA servers 20 to convert the telephony events.

### Media Forking

Just as in media recording, media forking is sometimes required during Call Progress Analysis (CPA) when a participating caller device 12 or callee device 14 is subject to receive a copy of the audio while call progress analysis is taking place.

### CPA Service Feature

Another type of service provided by the communication node 10 of the present invention is the CPA service feature. CPA (Call Progress Analysis) is a generic term for signal processing algorithms that operate on audio during call setup such as on pre-connection events and post-connection events. The goal of CPA is to determine the nature of the callee or the outcome of call establishment. The CPA outcome is typically used in call centers by applications such as predictive dialer and outbound dialers.

Possible outcome of pre-connection failure include busy tone, reorder tone, special information tones, etc. Alternatively, possible outcome of post-connection detection include human, hangup, silence, answering machine, answering machine message complete, fax, modem, etc.

In the context of the present invention, following receipt of a service request related to CPA by the caller device 12 or the callee device 14, the session controller module 18 sends a request to the internal SIP UA server 20 that are adapted to execute the tasks related to the CPA service features.

In the context of the present invention, the internal SIP UA server 20 is capable of handling, independently or in cooperation with other internal SIP UA servers 20, various issues related to the media stream. It is however to be understood that other applications and ways of using the internal SIP UA server 20 are not excluded by the present invention.

### Scripting

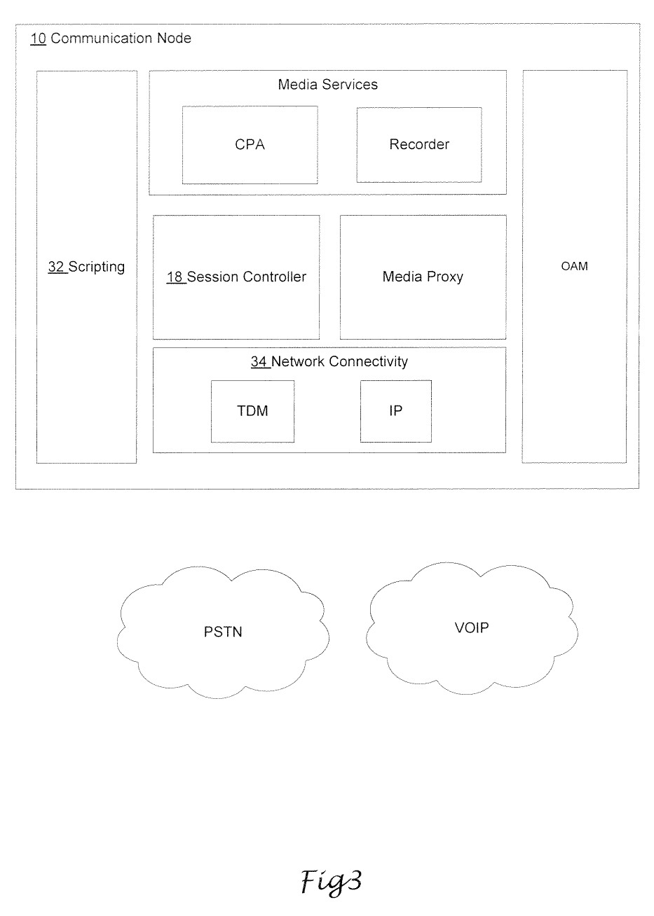

Turning now to FIG. 3, there is depicted a block diagram depicting another embodiment of the communication node of the present invention. In this particular embodiment, the communication node 10 comprises a scripting module 32. The scripting module 32 provides scripts to be executed for fulfilling received service request messages, to be requested by the session controller module 18. During the establishment of a call, the session controller module 18 receives a service request message from the caller device 12. The received service request message is analyzed by the session controller 18 to determine which script to execute by the scripting module 32. The scripting module 32 then executes the script identified by the session controller 18 and establishes the call by determining the location of the callee device 14 from the content of the received service request message.

The scripting module 32 provides the list of services that are required to perform the received service request message. The session controller module 18, based on the input of the script determines which internal SIP UA servers 20 is/are required with respect to the capabilities of each caller device 12 and callee device 14.

### Network Connectivity Module

The communication node 10 may further comprise a network connectivity module 34 for resolving network connectivity incompatibility issues. As the communication node 10 may be involved with different kinds of networks, presence the network connectivity module 34 may be particularly important for addressing the incompatibility issues related thereto. The network connectivity module 34 is capable of interpreting TDM (Time Division Multiplexing) transmission, used in CS (Circuit Switch) networks. Additionally, the network connectivity module 34 is capable of interpreting IP (Internet Protocol) transmission, used in PS (Packet Switch) networks. The network connectivity module 34 may further be capable of supporting resolution of network incompatibilities for a wide range of networks not described herein.

### Communication Between Modules

### SIP Messages

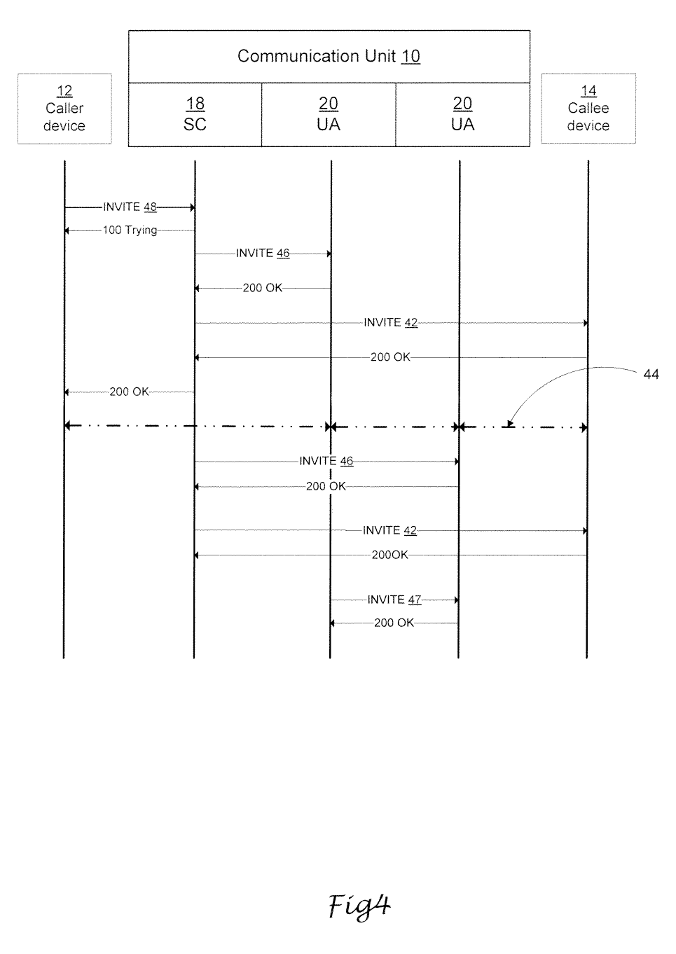

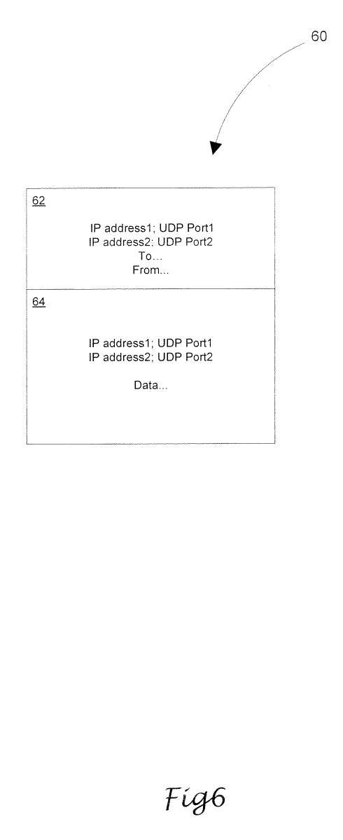

The service request message received by the communication node 10 of the present invention includes SIP message. An example of high-level structure of a SIP message is depicted in FIG. 6. The SIP message 60 comprises a header 62 and a message body 64. The header 62 comprises information useful for signaling, i.e. IP address and port number of the caller device 12 and of the callee device 14. The signaling port may be a UDP (User Datagram Protocol) port or any other type of port capable of receiving signaling. The information found in the header 62 is used by the session controller module 18 for establishing and maintaining communication over a signaling path 42 (depicted in FIG. 4).

The message body 64 comprises data. To enable the transfer of the data, the message body 64 additionally comprises an IP address and media port number of the caller device 12 and the callee device 14. The media port number may be an RTP (Real-Time Transport Protocol) port or any other type of port capable of receiving data. The information found in the message body 64 is used by the session controller module 18 and the internal SIP UA server 20 adapted to handle the media proxy service feature for transferring data over the media path 44 (depicted in FIG. 4).

Essentially, the message 60 is received from the caller device 12 by the communication node 10, slightly modified or arranged by the communication node, and sent, after required modification or arrangement from the communication node 10 to the callee device 14.

IP address and Ports

Reference is now made to FIG. 5, which depicts interposing of the communication node 10 between the caller device 12 and the callee device 14, and its corresponding repercussions on the messages there between. During the establishment of a communication between the caller device 12 and the callee device 14, the session controller module 18 first establishes communication with the caller device 12 and the callee device 14 over the signaling path.

The session controller module 18 first connects with the caller device 12 and the callee device 14 over the signaling path via the signaling ports 52. If a request for transferring data over the media path is received, the session controller module 18 gets the media proxy UA 20 involved by relaying the IP address and the media port 54 numbers of the caller device 12 and the callee device 14 to the media proxy. Once the relay to the internal SIP UA server 20 of the IP address and the media port 54 numbers has been successfully executed, the internal SIP UA server 20 takes over the communication over the media path.

### Communication Between SC and SIP UA

The session controller module 18 transfers SIP messages to the internal SIP UA servers 20 and vice-versa.

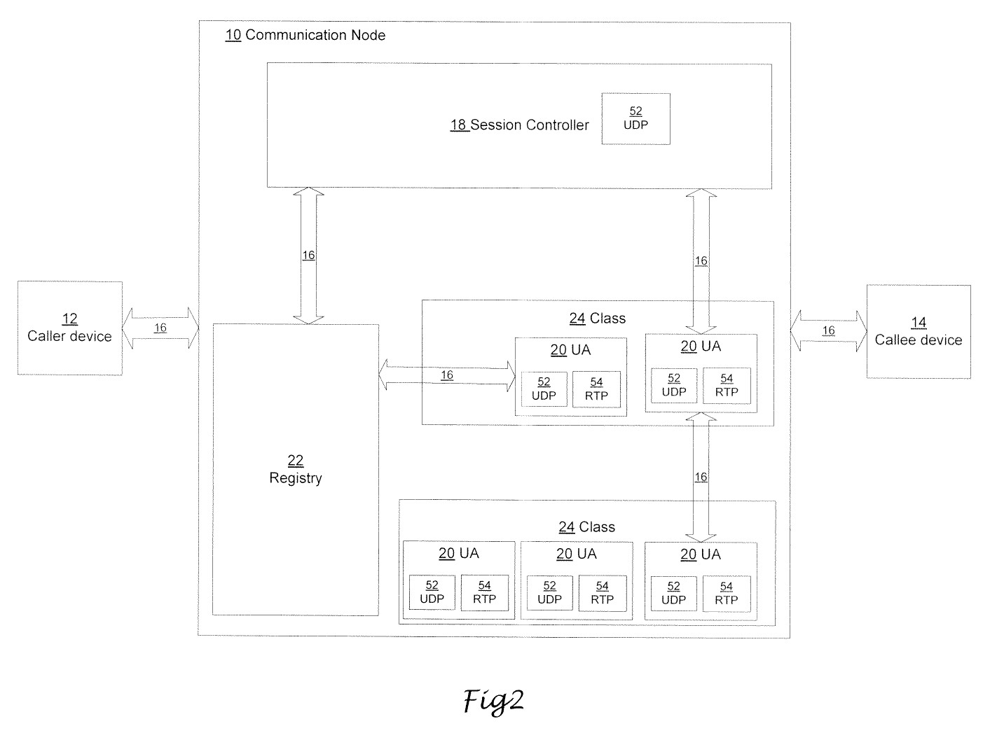

Presented concurrently in FIGS. 2 and 5, according to an embodiment of this invention, the communication node 10 comprises a session controller module 18 that communicates directly with a plurality of internal SIP UA servers 20. The session controller module 18 has an IP address, at least one signaling port 52. Similarly, each internal SIP UA server 20 has an IP address and at least one port such as a signaling port 52 and/or a media port 54. For instance, if the internal SIP UA server 20 is dedicated to the media proxy service feature, the internal SIP UA server 20 uses a media port 54 for data transferred (also called alternately media throughout the present specification) over the media path.

It is with the combination of IP address and signaling port 52 that the session controller module 18 is capable of identifying and transferring SIP messages to the internal SIP UA servers 20.

Depending on the function of the service feature to execute, the internal SIP UA servers 20 are adapted to participate in the execution of the service independently or in cooperation with other internal SIP UA servers 20. To participate in the execution of the service in cooperation with other internal SIP UA server(s) 20, according to an embodiment of this invention, the internal SIP UA servers 20 are adapted to communicate with each other by transferring SIP messages. In an alternate embodiment, the cooperating internal SIP UA servers 20 are not adapted to communicate with each other. In this case to participate in the execution of the service by cooperating with other internal SIP UA servers 20, the session controller module 18 manages the execution of the service by dispatching tasks to cooperating internal SIP UA servers 20 for the execution of the service.

### Usage of Registry

The communication node 10 of the present invention may further include a registry 22, as shown on FIG. 2. The registry 22 stores information with respect the internal SIP UA servers 20. For doing so, the registry 22 is kept updated with the following information: IP address, signaling port, media port, status, capabilities, etc, for each internal SIP UA server 20 within the communication node 10.

There are several ways for updating the availability status of internal SIP UA servers 20 in the registry 22. One way relies on the session controller module 18 for updating the registry 22 with the status internal SIP UA servers 20 whenever the internal SIP UA servers 20 are made available and whenever the internal SIP UA servers 20 are chosen for participating in the execution of a service request.

Another way of updating the registry is to rely on having the internal SIP UA servers 20 for reporting their status, or change thereof, to the registry 22.

The registry 22 may also be used by the session controller 18 for identifying which internal SIP UA server 20 to involve in a service request. Once the session controller module 18 has determined which functions must be executed for the requested service, the session controller module 18 communicates with the registry 22. As a result, the session controller module 18 is capable of determining to which internal SIP UA server(s) 20 the task(s) must be sent for execution based on availability and capability.

As the communication node 10 of the present invention is flexible and scalable, it is possible for an operator to add additional internal SIP UA servers 20 thereto. When the added internal SIP UA servers 20 are started, the registry 22 is populated with, among others, the address and port information by which the internal SIP UA servers 20 can be reached.

### SIP UA Assignation to Classes

In another aspect of the present invention, groups of internal SIP UA servers 20 are combined in classes 24. The classes may be formed of internal SIP UA servers 20 having similar capabilities for facilitating the management of internal SIP UA servers 20. Alternatively, the classes may be formed of internal SIP UA servers 20 having complementary capabilities for efficiently executing a particular service.

If desired, it is possible to designate one of the internal SIP UA server 20 of each class as a primary internal SIP UA server 20 and another one as a secondary internal SIP UA server 20 for redundancy purposes. Depending on the needs and implementation specific requirements, there may be multiple primary and secondary internal SIP UA servers 20 for a given class 24.

### Example of a Call Flow

Reference will now be made to FIG. 4, to assist in the following description of an example of a call session 40 in the context of the present invention. The call session 40 comprises a signaling path 42 and a media path 44. In VoIP, the call session 40 comprises one or more call signaling paths 42 that control the call, and one or more media paths 44, which carry audio, video and/or other data. The session controller module 18 exerts control over the call session 40 by getting involved in establishing, conducting and tearing down the call session 40.

For doing so in an efficient manner, the communication node is adapted to insert itself in the media path 44 only if absolutely required. Once the media path 44 has been established, unless absolutely required, the session controller module strives to keep the node 10 out of the media path 44, while remaining in the signaling path 42 until the tearing down of the call session 40. As a result, the withdrawal of the communication node 10 from the media path 44 reduces resource consumption related with media processing. For instance, the cost of CPU (Central Processing Unit) resource consumption is thereby greatly reduced, which in turn makes it possible for the communication to assist many more caller devices 12 and callee devices 14 simultaneously.

As the session controller module 18 remains in the signaling path 42 for the whole duration of the call session 40, it becomes possible for the communication node 10 to resolve compatibility and connectivity issues during the whole duration of the call session 40. Additionally, the communication node 10 is capable of providing any other service previously described throughout the whole duration of the call session 40.

The session controller module 18 is adapted to remain in the signaling path 42 through out the whole duration of the call session 40 by interposing itself between the caller device 12 and the callee device 14.

According to another embodiment, the communication node 10 further interposes at least one internal SIP UA server 20 between the caller device 12 and the callee device 14.

When the session controller modules 18 requires functions of one of a service feature to be executed, the session controller module 18 sends a request 46 to the internal SIP UA server 20 adapted to execute the desired functionalities of the requested service feature. When multiple internal SIP UA servers 20 are required to cooperate for the execution of the requested service feature, internal SIP UA servers 20 may further be capable to communicate between each other by use of inter-SIP UA requests 47.

### Other Possible Communication Node Architectures

Various variants may be performed to the architecture of the present invention, for achieving or optimizing the flexibility and scalability desired. For example, in a communication node 10 requiring extremely low downtime periods, load-balancing or greater resilience, it might be preferable to provide redundant session controller 18, internal SIP UA servers 20, registry 22 etc.

By its design and architecture, the communication node 10 of the present invention is thus highly flexible, scalable, and capable of ensuring connection of a communication and proper support of required services throughout the communication.

The present communication node and method have been described with regard to various possible embodiments. The description as much as the drawings were intended to help the understanding of the method and communication node, rather than to limit their scope. Various modifications may be made to the present invention without departing from the scope of protection sought in accordance with the appended claims.

1. A communication node for connecting and maintaining a call session between a caller device and a callee device, the communication node comprising:
a session controller module adapted to interpose itself between the caller device and callee device through a whole duration of the call session there between; and
a plurality of internal Session Initiation Protocol User Agent (SIP UA) servers, each of the internal SIP UA servers being adapted to communicate with the session controller module by open protocol for providing at least one service during the call session.

2. The communication node of claim 1 wherein the at least one service is for resolving media compatibility issues between the caller device and the callee device.

3. The communication node of claim 2 wherein the at least one service is for resolving signaling conflict issues between the caller device and the callee device.

4. The communication node of claim 1, wherein the session controller module is adapted to dispatch a task to at least one of the plurality of internal SIP UA servers.

5. The communication node of claim 4, wherein the communication node further comprises a registry storing information and status for the plurality of internal SIP UA servers, and wherein the session controller module is adapted to access the registry.

6. The communication node of claim 1, wherein at least one of the plurality of internal SIP UA servers is adapted to communicate with at least another one of the plurality of internal SIP UA servers by open protocol.

7. The communication node of claim 1, wherein the session controller is further adapted for withdrawing the communication node from a media path during the call session.

8. The communication node of claim 1, wherein some of the plurality of internal SIP UA servers are grouped as a class.

9. The communication node of claim 1, wherein the at least one service is for resolving RFC3261 SIP standard compatibility issues between the caller device and the callee device.

10. A communication node for handling SIP communication, the communication node comprising:
a session controller module capable of supporting SIP (Session Initiation Protocol) communication, the session controller module being adapted to remain in communication with a caller device and a callee device through a whole duration of a call session there between, the session controller module further acting as an internal B2BUA (Back to Back User Agent);
a plurality of internal SIP UA (User Agents) servers for providing services to the caller device and the callee device, the plurality of internal SIP UA servers communicating with the session controller module through open protocol.

11. The communication node of claim 10 wherein the at least one service is for resolving signaling conflict issues between the caller device and the callee device.

12. The communication node of claim 11 wherein one of the at least one service is for resolving media compatibility issues between the caller device and the callee device.

13. The communication node of claim 10, wherein the session controller is adapted for withdrawing the communication node from a media path during the call session.

14. A method for handling SIP communication between a session controller module and at least one internal SIP UA (User Agent) server comprising:
delegating at least one task to at least one internal SIP UA server by the session controller module; and
maintaining communication by the session controller module with a caller and a callee through a whole duration of a call session.

15. The method for handling SIP communication of claim 14 further comprising:
updating a registry for storing an identity of the at least one internal SIP UA server that is available and adapted to execute the at least one task; and
accessing the registry for identifying the at least one internal SIP UA server that is available and adapted to execute the at least one task.

16. The method for handling SIP communication of claim 15 further comprising:
establishing communication between at least two internal SIP UA servers for executing the at least one task.

17. The method for handling SIP communication of claim 16 further comprising:
withdrawing the communication node from a media path during the call session.
